(19) United States
(12) Patent Application Publication
(10) Pub. No.: US 2007/0228022 A1
(43) Pub. Date: Oct. 4, 2007

(54) LASER WELDED BROADHEAD

(76) Inventor: Philip Muller, Mercerville, NJ (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/758,710

(22) Filed: Jun. 6, 2007

Related U.S. Application Data
(62) Division of application No. 11/234,353, filed on Sep. 23, 2005.
Application No. 11/234,353 is a continuation-in-part of application No. 11/102,939, filed on Apr. 11, 2005.
Application No. 11/102,939 is a continuation of application No. 10/185,089, filed on Jun. 28, 2002, now Pat. No. 6,939,258.
Application No. 11/102,939 is a continuation-in-part of application No. 09/922,550, filed on Aug. 4, 2001, now Pat. No. 6,726,581.
Application No. 10/185,089 is a continuation-in-part of application No. 10/094,125, filed on Mar. 8, 2002, now Pat. No. 6,605,012.
(60) Provisional application No. 60/354,214, filed on Feb. 4, 2002.
(60) Provisional application No. 60/365,249, filed on Mar. 18, 2002.
(60) Provisional application No. 60/265,114, filed on Jan. 31, 2001.
(60) Provisional application No. 60/293,307, filed on May 24, 2001.
(60) Provisional application No. 60/273,819, filed on Mar. 8, 2001.
(60) Provisional application No. 60/286,030, filed on Apr. 24, 2001.

(51) Int. Cl. B23K 26/20

(52) U.S. Cl. 219/121.63

(57) ABSTRACT

A broadhead including parts inseparably connected by laser welding.

### CROSS-REFERENCE TO RELATED APPLICATIONS

This application claims priority to, and is a divisional application of, U.S. patent application Ser. No. 11/234,353, filed Sep. 23, 2005. That application in turn is a continuation-in-part of, and incorporates by reference U.S. patent application Ser. No. 11/102,939 filed Apr. 11, 2005, which in turn claims priority to U.S. Pat. No. 6,939,258, filed Jun. 28, 2002 (the “'258 Patent”). The '258 patent claims priority, to: (1) U.S. Provisional Patent Application No. 60/354,214, filed Feb. 4, 2002, (2) U.S. Provisional Patent Application No. 60/365,249, filed Mar. 18, 2002; (3) U.S. Pat. No. 6,726,581, filed Aug. 4, 2001 (continuation-in-pant), which claimed priority to U.S. Provisional Patent Application No, 60/265,114, filed Jan. 31, 2001, and U.S. Provisional Patent Application. No. 60/293,307, filed May 24, 2001, and (4) U.S. Pat. No. 6,605,012, filed Mar. 8, 2002 (continuation-in-part), which claimed priority to U.S. Provisional Patent Application No. 60/273,819, filed Mar. 8, 2001, and U.S. Provisional Patent Application No. 60/286,030, filed Apr. 24, 2001.

### STATEMENT REGARDING FEDERALLY SPONSORED RESEARCH

Not applicable.

### NAMES OF PARTIES TO A JOINT RESEARCH AGREEMENT

Not applicable.

### SEQUENCE LISTING

Not applicable.

### BACKGROUND

1. Technical Field

The description contained herein generally relates to archery equipment. More particularly, the present invention relates to a broadhead for hunting arrows, having parts permanently joined by a laser weld.

2. Description of the Related Art

Traditionally, archery broadheads are made from multiple pieces that are fitted together. The pieces may include individual blades, a tip, and/or other connecting parts. Traditional broadheads also include a means for connecting the broadhead to an arrow, such as a receptacle designed to fit over or in the shaft of an arrow, with threads or glue to secure the broadhead to an arrow. However, such broadheads can be expensive to manufacture, and they can become loose, and their parts may even separate, through use or transport.

Prior art broadheads may be relatively complex, usually with many pieces including quite often individual blades that must be Joined together like a puzzle.

Accordingly, I have found that it is desirable to provide an improved broadhead.

### SUMMARY

In accordance with one embodiment, a broadhead includes a plurality of parts, wherein at least two of the pans are permanently fastened together at a laser welded seam. In various embodiments, the parts may include at least one blade, cap, collar, tip structure, or ferrule. The parts may include a tip structure having at least two blades. In some embodiments, no flux or other filler material has been added to the seam. The seam may be a spot welded, overlapping spot welds, or other seam.

In accordance with an alternate embodiment, a method of manufacturing a broadhead includes arranging multiple components or parts of a broadhead. An energy beam is directed toward contact segments (i.e., locations where at least two components are in contact or close proximity) to weld the components or parts. The components may include blades, a tip structure, a cap structure for receiving a separable ferrule, and/or a collar for receiving a separable ferrule, or a ferrule itself. In embodiments, the energy beam may be a laser, and the method may include focusing the energy beam toward a contact segment using one or more devices such as a focus cell, a lens, and/or a mirror. A focal point of the energy beam may be moved along a contact segment.

Optionally, multiple energy beams may be directed toward a multiple of contact segments simultaneously, wherein each energy beam is directed toward a particular contact segment.

### BRIEF DESCRIPTION OF THE DRAWINGS

FIG. 1 a prior art monolithic broadhead.

FIG. 2 illustrates an exploded view of one embodiment of a welded blade unit, with a separate ferrule.

FIG. 3 is a non-exploded view of the blade unit of FIG. 2, also illustrating a separate ferrule before the ferrule engages with the blade unit.

FIG. 4 illustrates an alternate embodiment, showing an exploded view of a unitary broadhead.

FIG. 5 illustrates an exemplary laser welding process.

FIG. 6 provides a close-up view of an exemplary tip structure for a broadhead as produced by the laser welding process of FIG. 5.

### DETAILED DESCRIPTION

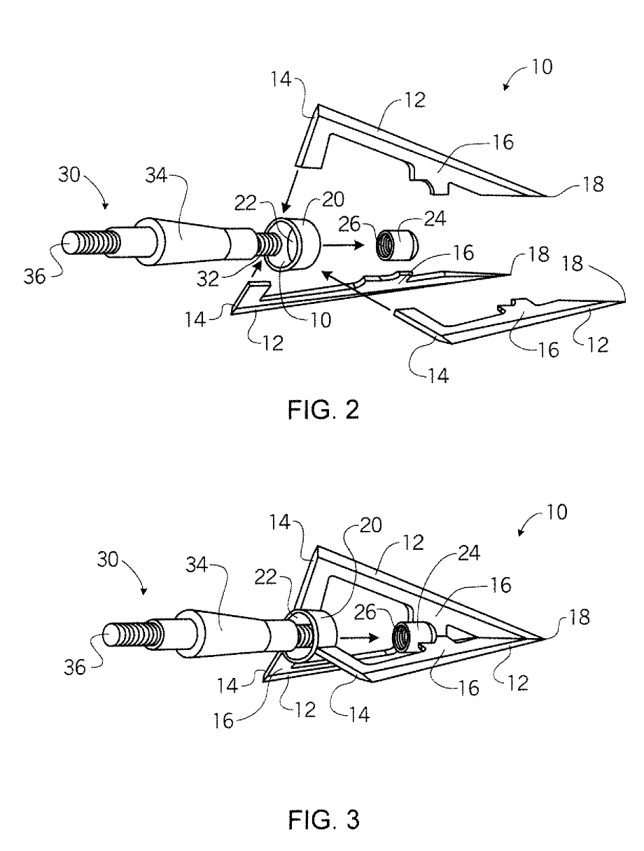

FIGS. 2 and 3 illustrate a first embodiment of a welded broadhead. FIG. 2 illustrates an expanded view of a blade unit as it receives a ferrule, while FIG. 3 illustrates an as-built view of the embodiment while receiving a ferrule. Referring to FIGS. 2 and 3, blade unit 10 includes three blades 16. More or less than three blades may be used, although three is a preferred number of blades. Each blade 16 has a razor edge 12 and a base 14.

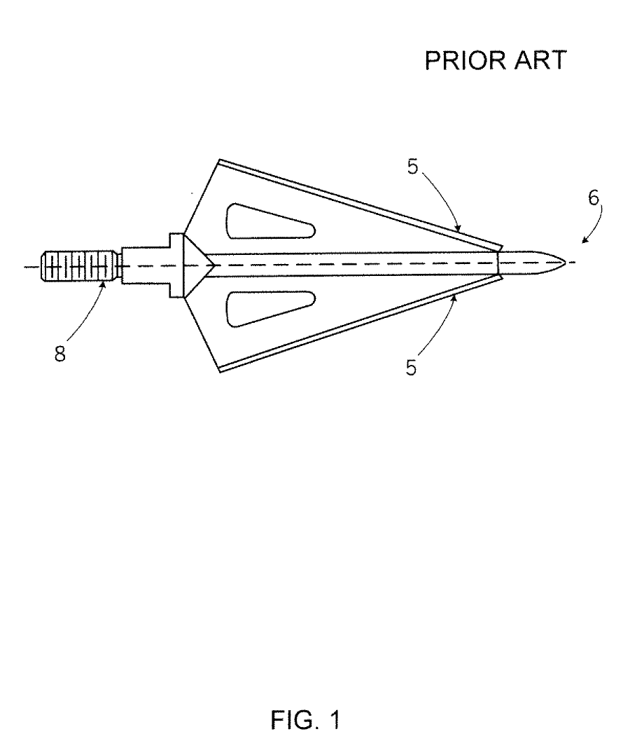

In the embodiment illustrated in FIGS. 2 and 3, each blade extends radially from a common frontal point 18 to its base 14. Preferably, and as illustrated, frontal point 18 is formed by the intersection of the at least two of the razor edges 12 to provide the ability to cut a target with the razor edges 12 on contact. Such a tip is sometimes referred to as a “chisel-type” or “cut on contact” tip. However, optionally and alternatively the frontal point 18 may comprise another tip, such as a conical, cylindrical, pyramid-shaped, screwdriver-tip-shaped or any other type of point that provides a shield or initial contact point over or adjacent to a frontal area of the blades for a “punch cut” before the razor edges meet the target. An example of a conical tip 6 for a punch cut is shown in FIG. 1.

Returning to FIGS. 2 and 3, the blades 16 are interconnected to provide a single, solid blade unit 10. This may be done by welding the three blades 16 together using laser welding techniques such as those described below. The weld may be applied at the tip where the blades intersect. One or more welds may also be applied at a base where the blades intersect with each other and/or with a ferrule, collar cap, or other base member.

In the embodiment shown in FIGS. 2 and 3, the base 14 of each blade 16 is connected to a base collar 20 that has a central aperture 22 in alignment with a cap 24. The cap 24 is connected to an interior portion of each blade 16 at a location that is between the collar 20 and the frontal point 18. The cap 24 has a first means for receiving a ferrule 30 after a ferrule 30 is passed through the central aperture 22 of the base collar 20. As illustrated in FIGS. 2 and 3, the means for receiving the ferrule is a series of threads 26, which optionally may be tapered to mate with a tapered series of threads 32 on the ferrule 30. However, other means, such as tabs, holes and pins, or other mechanisms are possible. As used herein, the term “ferrule” means a central shaft or any other optionally central device that connects the blade to the shalt of an arrow. FIGS. 2 and 3 illustrate an exemplary ferrule 30 having a body 34, threads 32 for connecting the ferrule to the blade unit, and threads 36 for connecting the ferrule to an arrow shaft. Again, other means, such as tabs, holes and pins, or other jointing mechanisms are possible providing one such joint is a laser welded seam.

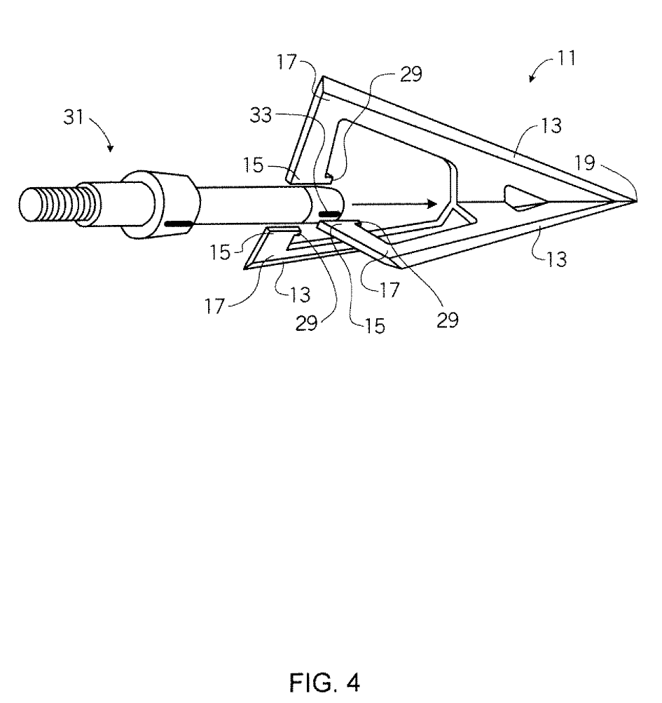

In an alternate embodiment, as illustrated in FIG. 4, instead of being separable from the blade unit, ferrule 31 is directly bonded to the blade unit using laser welding techniques. Although not required, a ferrule 31 may be equipped with slots 33 or other means to further secure the bases 15 of each blade 17. When such an option is present, bases 15 of each blade may include a projection 29 such as a tab to further secure the base 15 to the slot 33. However, whether or not this option is used, the laser welds secure the blade unit 11 to the ferrule 31 to create a broadhead with a laser welded seam.

Returning to FIGS. 2 and 3, the embodiment using a base collar 20 may also include an optional means for connection to a ferrule 30. Such a means may include, for example, a taper, preferably about two degrees to about ten degrees, more preferably about five degrees, to mate with the ferrule and prevent it from moving through a force fit. The taper may be on the body 34 of the ferrule, as shown in FIGS. 2 and 3, or it may be elsewhere.

In the embodiment of FIGS. 2 and 3, the blade unit 10 may receive the ferrule 30 when a person or device inserts the front portion of the ferrule 30 through the base collar 20 until the front portion (such as threaded area 32) is received by the cap 24. The ferrule 30 is then rotated such that the threaded area 32 screws into the cap 24. As the front portion 32 is drawn into and connects with the cap 24, the central portion 34 of the ferrule is drawn into, mates inside of, and tightens in the central aperture 22 of the base collar 20. By screwing the ferrule 30 tightly into the blade unit 10, a secure connection is made. Of course, as mentioned above, other means of connection, such as pins or locking tabs, may be used. Examples of blade units that may connected by tabs 15 and/or grooves 33 with laser welds are show in FIG. 4. Optionally tabs, grooves, and threads may be omitted, with all connections of ferrule and blade unit being made through welding.

The frontal point 18 of the blade unit is the first part that will contact a target. Since it is just a point, and since it will receive a tremendous force upon impact, it is preferred that the blade unit be constructed in such a way that it has additional strength. This can be accomplished by grinding and sharpening the razor edges 12 after they are welded together. Grinding and sharpening of the blades may be performed before or after the laser weld occurs.

The welded parts of a broadhead may include blades, ferrules, caps, collars, or any part required to make up the broadhead. The unitary blade unit or broadhead may be made of any metal. For example, the blades, blade unit, other parts or the entire broadhead may be made using carbon steel, aluminum, stainless steel, spring steel, tool steel or titanium, or a composition including any of the above.

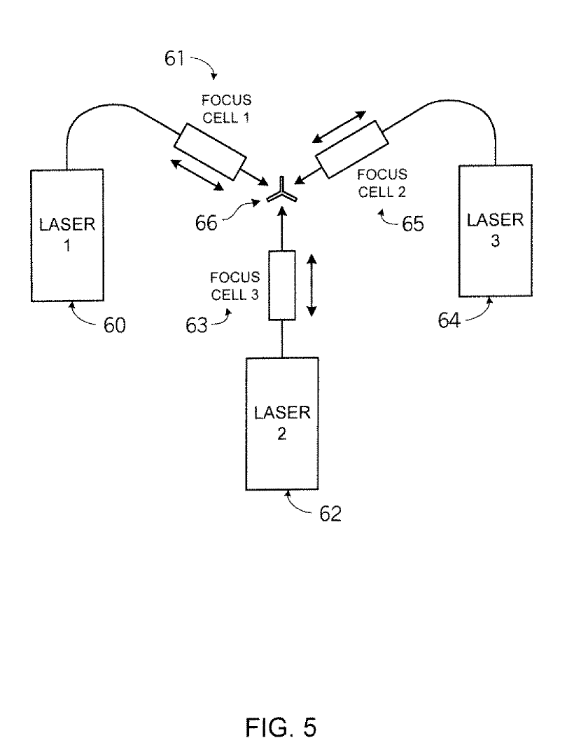

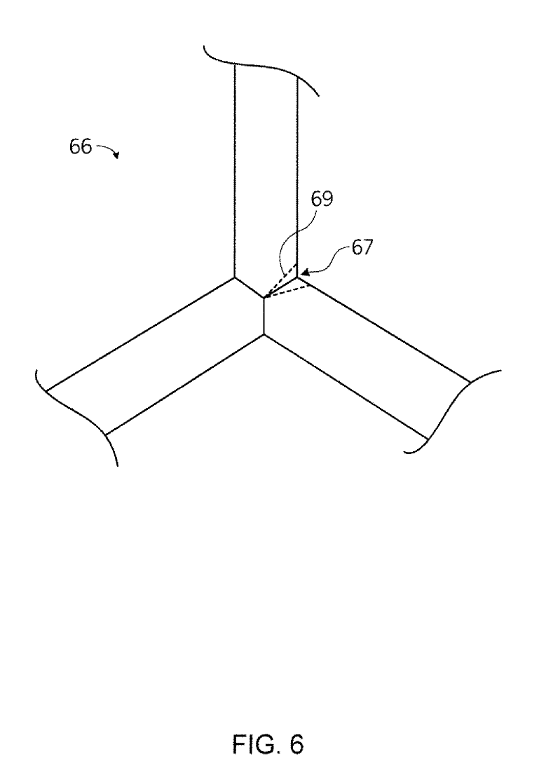

The blade unit and/or broadhead may be made by assembling the blades into a unitary structure. Referring to FIG. 5, a laser unit 60 directs a beam of energy toward an intersection of two blades of an exemplary blade unit 66. A closer view of the tip structure of blade unit 66 is provided in FIG. 6, which also shows the points of intersection 67. The beam of energy is preferably directed toward the intersection 67 using a focus cell 61, mirror, or other device that focuses the beam toward the point of intersection. The energy beam fuses the blades at the point of intersection 67. Thus, as shown in FIG. 6, the laser welding process provides a very small heat affected zone 69 at the intersection. Such a laser welded seam may be created at any joint or intersection of parts in the broadhead. The small heat affected zone provides a laser welded seam that does not result in deformity of the blades or other parts, Thus, a fluxless seam may provide a broadhead in which the weight balance is not adversely affected in any substantial manner by the presence of flux or filler material. However, laser welding with flux or filler material, preferably in small amounts, is also within the scope of the invention in various embodiments. In addition, the welding may be performed either before or after the parts have been tempered or otherwise hardened.

This process is performed for each point of intersection, preferably simultaneously with multiple lasers and focus cells such as is shown in FIG. 5, but optionally with a single laser that welds on a joint-by-joint basis. Preferably, the weld is performed into the tip structure to provide a “cut on contact” tip. However, alternate tip structures are possible. In addition, laser welding is preferably used to connect the ferrule to the blade structure.

The process of welding broadhead parts together may be performed using a Neodymium-doped Yttrium Aluminum Garnet (Nd:YAG) laser device. The Nd-YAG laser may operate in a pulsed mode, continuous mode or both. Other operational characteristics are possible. A laser weld produced by an Nd:YAG laser does not require any filler material or flux, and need not have any direct physical contact with the part that is to be welded. Accordingly, laser welding can yield a blade unit that does not have the increased weight and compositional variability that may result from the introduction of flux into the weld points. However, flux may be used with a laser welding method and still be within the scope of the present invention. Preferably, the laser is operated in a pulse mode with a surface temperature below boiling point to produce a limited weld without deformation of the broadhead parts. Alternatively, the laser welding may be performed using a carbide dioxide (CO2) or other laser that is capable of producing a weld but does not require flux or other filler material, although flux or filler may optionally be used in some embodiments. The weld may be either a spot weld, in which heat transport occurs predominantly by conduction so that melting of the material occurs thus fusing the material together when it cools. Alternatively, the weld may be a seam weld, produced by a sequence of overlapping spot welds or by the formation of a continuous molten weld pool.

The many features and advantages of the invention are apparent from the detailed specification. Thus, the invention is intended to include all such features and advantages of the invention which fall within the true spirits and scope of the invention. Further, since numerous modifications and variations will readily occur to those skilled in the art, it is not desired to limit the invention to the exact construction and operation illustrated and described in the specification, claims, and drawings herein. Accordingly, all appropriate modifications and equivalents may be included within the scope of the invention.

What is claimed is:

1. A method of manufacturing a broadhead, wherein the broadhead comprises a plurality of parts and at least one blade, the method comprising:
assembling a first part together with a second part to create an intersection;
directing a beam of energy from a laser unit toward the intersection to fuse the first part with the second part at a seam.

2. The method of claim 1, wherein the directing further comprises using at least one of a focus cell, a lens, or a mirror to direct the beam of energy toward the intersection.

3. The method of claim 1, wherein neither flux nor filler material is added to the seam.

4. The method of claim 1, wherein before the directing, at least one of flux and filler material is added to the seam.

5. The method of claim 1, wherein the directing comprises spot welding.

6. The method of claim 1, wherein the seam comprises overlapping spot welds.

7. The method of claim 1, wherein the broadhead has a weight balance that is not adversely affected in any substantial manner by any flux or filler material.

8. The method of claim 1, wherein the first part or the second part comprises a blade.

9. The method of claim 1, wherein the directing provides a small heat affected zone that provides a seam that does not result in deformity of the first part or the second part.

10. The method of claim 1, wherein the directing has no physical contact with the first part or the second part.

11. A method of manufacturing a broadhead, wherein the broadhead comprises a plurality of parts and at least one blade, the method comprising:
assembling a first part together with a second part to create an intersection; and
directing a beam of energy from a laser unit toward the intersection to fuse the first part with the second part at a seam, wherein the directing provides a small heat affected zone that provides a seam that does not result in deformity of the first part or the second part;
wherein the broadhead has a weight balance that is not adversely affected in any substantial manner by any flux or filler material.

12. The method of claim 11, wherein neither flux nor filler material is added to the seam.

13. The method of claim 11, wherein before the directing, at least one of flux and filler material is added to the seam.

14. The method of claim 11, wherein the directing comprises spot welding.

15. The method of claim 11, wherein the scam comprises overlapping spot welds.

16. The method of claim 11, wherein the first part or the second part comprises a blade.

17 The method of claim 11, wherein the directing has no physical contact with the first part or the second part.

18. The method of claim 1, wherein the first part and the second part each comprise a blade and the method further comprises:
directing a beam of energy to fuse the blades to a base member at a point of intersection.

19. The method of claim 18, wherein the base member comprises a ferrule having a body and a threaded area, and the point of intersection includes a portion of the body.
